(19) United States
(12) Patent Application Publication
(10) Pub. No.: US 2009/0321393 A1
(43) Pub. Date: Dec. 31, 2009

(54) CURRENT-LIMITING ARC-QUENCHING DEVICE

(75) Inventors: Thilo BAHLINGER, Rulzheim (DE); Joachim Becker, Schwetzingen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/537,155

(22) Filed: Aug. 6, 2009

Related U.S. Application Data
(63) Continuation of application No. PCT/EP2008/000895, filed on Feb. 6, 2008.

(30) Foreign Application Priority Data
Feb. 7, 2007 (DE) 10 2007 005 997.5

(51) Int. Cl. H01H 33/04

(52) U.S. Cl. 218/149

(57) ABSTRACT

A current-limiting arc-quenching device for an electric switching device is disclosed having at least one contact point that has a fixed and a movable contact piece, an arc-quenching laminated core, which is situated between a fixed contact guide bar and an arc baffle that is associated with the movable contact piece, being connected to the contact point in such a way that the feet of a switching arc, which is generated when the contact point is opened, run along the fixed contact guide bar and the arc baffle. The switching arc travels into the arc-quenching laminated core, where it is quenched. The device is configured such that the fixed contact guide bar and the arc baffle are coated with another material in areas bordering the arc-quenching laminated core.

### RELATED APPLICATIONS

This application claims priority as a continuation application under 35 U.S.C. §120 to PCT/EP2008/000895, which was filed as an International Application on Feb. 6, 2008 designating the U.S., and which claims priority to German Application 10 2007 005 997.5 filed in Germany on Feb. 7, 2007. The entire contents of these applications are hereby incorporated by reference in their entireties.

### FIELD

The disclosure relates to a current-limiting arc-quenching device, a service switching device having a current-limiting arc-quenching device, and a composite material for coating parts of a current-limiting arc-quenching device.

### BACKGROUND INFORMATION

Current-limiting arc-quenching devices for an electric switching device having at least one contact point that has a fixed and a movable contact piece are known. These devices include an arc splitter stack, located between a fixed contact guide rail and an arc guide rail that is associated with the movable contact piece, such that feet of a switching arc, which is generated when the contact point is opened, run along the fixed contact guide rail and the arc guide rail. The switching arc can travel into the arc splitter stack where it is quenched.

An example of such a current-limiting arc-quenching device of the kind described is disclosed in DE 40 41 887 A1.

On occasions, it has been proposed to apply special coatings, which assist the quenching of the arc, to the individual arc splitter plates in order to accelerate the quenching of the arc within the arc-quenching laminated core.

For example, DE 32 47 681 discloses an arc-quenching chamber with an arc splitter stack assembly, each arc splitter plate being coated with a gas- or vapor-emitting material, which vaporizes under the effect of the arc and thereby promotes quenching of the arc.

However, for rapid current limitation, it is not only desired for the arc to be quickly quenched within the arc splitter stack assembly but also for it to be passed from the place at which it originated to the arc splitter stack assembly quickly. In order to minimize the time taken for the arc to travel from the point at which it originates to the arc splitter stack assembly, the arc is accelerated away from the contact point towards the arc splitter stack by magnetic forces produced by additional so-called blowing magnets or by suitably arranged conductor loops.

However, in the event of high short circuit currents, the fixed contact guide rail and arc guide rail then can exhibit a high degree of material fusing after the arc has been quenched. This can limit the life in the event of a short circuit and the magnitude of the maximum switching capability of the switching device. At the same time, the limitation of the maximum switching capability can result from short circuits which are caused by material of the fixed contact guide rail and arc guide rail which is fused on and subsequently spatters from the surface.

### SUMMARY

A current-limiting arc-quenching device for an electric switching device is disclosed, comprising at least one contact point that has a fixed and a movable contact piece, and an arc splitter stack (e.g., arc-quenching laminated core) for quenching a switching arc when generated, the arc splitter stack being located between a fixed contact guide rail and an arc guide rail (e.g., arc baffle) that is associated with the movable contact piece, such that feet of the switching arc, which is generated when the contact point is opened, run along the fixed contact guide rail and the arc guide rail, the switching arc traveling into the arc splitter stack, wherein the fixed contact guide rail and the arc splitter are coated with a coating material in areas which flank the arc splitter stack.

An electric switching device is disclosed, comprising at least one contact point that has a fixed and a movable contact piece, and a current-limiting arc-quenching device having an arc splitter stack for quenching a switching arc when generated, the arc splitter stack being located between a fixed contact guide rail and an arc guide rail that is associated with the movable contact piece, such that feet of a switching arc, which is generated when the contact point is opened, run along the fixed contact guide rail and the arc guide rail, the switching arc traveling into the arc splitter stack, wherein the fixed contact guide rail and the arc guide rail are coated with a coating material in areas which flank the arc splitter stack.

A composite material is disclosed for coating a fixed contact guide rail and an arc guide rail in areas thereof flanking an arc splitter stack in a service switching device, the composite material comprising a first constituent which is electrically conductive and has melting and vaporization points which do not exceed melting and vaporization points of a base material of the fixed contact guide rail and arc guide rail, and a second constituent which has melting and vaporization points which are higher than the melting and vaporization points of the base material of the fixed contact guide rail and arc guide rail.

### DESCRIPTION OF THE DRAWINGS

The disclosure as well as further exemplary embodiments and improvements of the disclosure are explained and described in more detail with reference to the drawings, in which an exemplary embodiment of the disclosure is shown.

FIG. 1: shows a partial view into an open service switching device having an exemplary current-limiting arc-quenching device according to the disclosure;

FIG. 2: shows an exemplary coated arc guide rail according to the disclosure; and

FIG. 3: shows an exemplary coated fixed contact guide rail according to the disclosure.

### DETAILED DESCRIPTION

Exemplary embodiments disclosed herein can increase the life and magnitude of the switching capability of current-limiting arc-quenching devices.

According to exemplary embodiments of the disclosure, therefore, a fixed contact guide rail and arc guide rail can be coated with a different coating material in areas thereof which flank an arc splitter stack, of arc splitter plates configured, for example, as a laminated core. The coating material can have different physical and chemical properties relative to a base material of the fixed contact guide rail and arc splitterarc guide rail. By choosing a suitable coating material, it is possible to prevent material fusing in the areas of the fixed contact guide rail and arc splitterarc guide rail flanking an arc splitter stack without the propagation speed of an arc at the fixed contact guide rail and arc guide rail being adversely affected as a result.

For example, the fixed contact guide rail and arc guide rail can be made from a ferromagnetic material.

In an exemplary embodiment, the fixed contact guide rail and arc guide rail are each coated with a material which increases the thermal stability in the area thereof flanking the arc splitter stack. Here, the area. or region, flanking the arc splitter stack is that part of the surface of the fixed contact guide rail and arc guide rail facing the adjacent, outer arc splitter plates of the arc splitter stack. When the arc enters the arc splitter stack, the first sub-arc occurs between this area flanking the arc splitter stack and the outer arc splitter plate, and the risk of surface fusing in this area is particularly high.

By coating with a material which increases the thermal stability, fusing can be prevented at this critical point, thus increasing the life and maximum switching capability.

In one exemplary embodiment, the coating material can be a metal with high electrical conductivity, for example silver or copper or other conductive material. Because of the high electrical conductivity, the foot (i.e., base) of the arc then travels more quickly in the coated area, that is to say each contact point between the arc and the surface of the fixed contact guide rail and arc guide rail is, for example, only thermally stressed for a very short time, as a result of which the thermal stressing overall is reduced.

In spite of this, fusing and spattering of metal particles can still occur from time to time.

An exemplary embodiment of the disclosure includes coating material which is a composite material comprising at least two constituents, the first constituent of which is electrically conductive and has melting and vaporization points which do not exceed the melting and vaporization points of the base material of the fixed contact guide rail and arc guide rail. The second constituent has melting and vaporization points which are higher than the melting and vaporization points of the base material of the fixed contact guide rail and arc guide rail.

Suitable material is, for example, disclosed in DE 10 2004 036 113 B4 which is incorporated herein by reference.

As a result of the first constituent, the composite material has adequately high electrical conductivity, and as a result of the second constituent, fusing and spattering of the coating material are largely prevented.

According to a further exemplary embodiment, an intermediate coating, which can improve adhesion and prevent diffusion, is also provided between the coating material and the base material of the fixed contact guide rail and arc splitter plate. An exemplary intermediate coating material is nickel, which also has an exemplary advantage of being ferromagnetic.

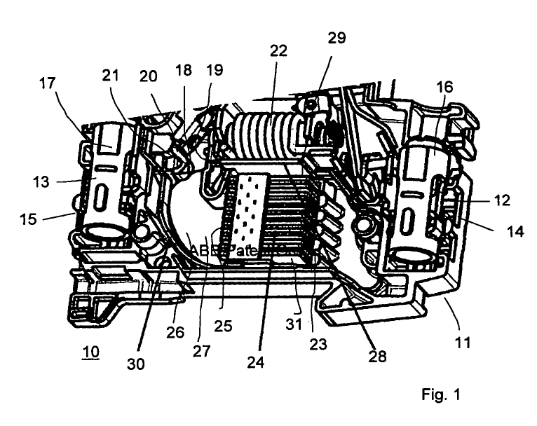

Consideration is first given to FIG. 1, which shows a partial view into an exemplary open service switching device 10, which in this case is a circuit breaker with a shell construction. It comprises a housing, which is made from insulating material and is assembled from two half-shells which abut one another at a connecting line, of which only the bottom half-shell 11 can be seen in FIG. 1, the top half-shell which completes the housing having been removed.

The components and assemblies for the operation of the circuit breaker are accommodated within the dielectric housing. The two connecting terminals 16, 17, between which the current path to be monitored by the circuit breaker 10 runs and which are accommodated in terminal mounting spaces 12, 13 on the narrow sides 14, 15 of the housing, can be seen.

In the current path lies a contact point 18 which is formed by a fixed contact piece 19 and a movable contact piece 21 attached to a swiveling contact carrier 20.

In the event of a short circuit current, the contact carrier 20 is struck away by the armature of an electromagnetic striker armature system 22, as a result of which the contact point 18 is suddenly opened and a switching arc occurs between the fixed and movable contact piece 19, 21.

To quench the switching arc, an arc splitter stack 24 made from arc splitter plates stacked parallel one above the other is provided in an arc-quenching chamber 23. An antechamber 26, to the walls of which flat permanent magnets 27, so-called blowing magnets, can be attached, is situated between the contact point 18 and the inlet 25 to the arc splitter stack 24.

The antechamber is bounded at the sides by a fixed contact guide rail 28, which, starting from the fixed contact piece 19, rests with its free end parallel to a first outer arc splitter plate 29 of the arc splitter stack 24 and thereby flanks the arc splitter stack 24 on its first outer side, and by an arc guide rail 30, which is associated with the movable contact piece 21 and, starting from this, rests with its free end parallel to a second outer arc splitter plate 31 and thereby flanks the arc splitter stack 24 on its second outer side.

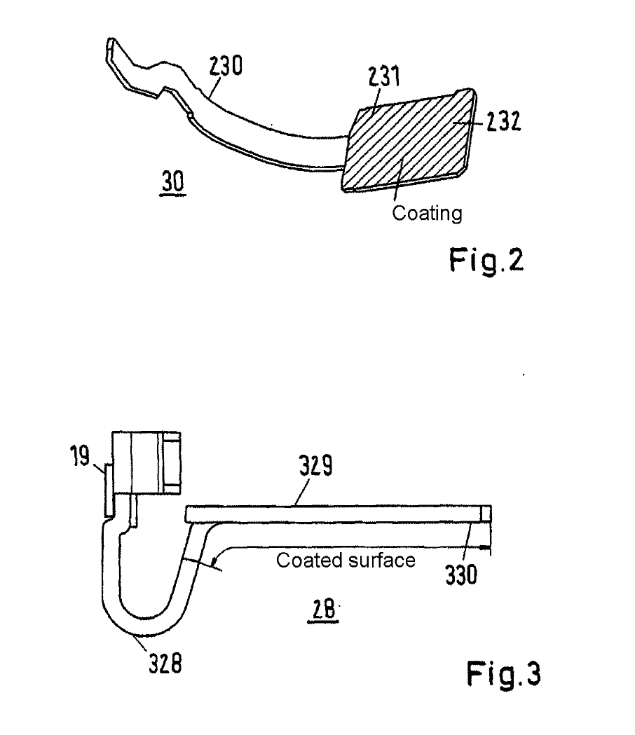

FIG. 2 shows an exemplary arc guide rail 30. It comprises a first, sheet metal strip 230, which is in the form of an arc and forms the outer boundary of the antechamber 26. To the free end of this is attached a roughly rectangular sheet metal part 231, which with its first broad side 232 flanks the second outer arc splitter plate 31 of the arc splitter stack 24. When entering the arc-quenching chamber 23, the arc, which has its first foot on the sheet metal strip 230, transfers from the sheet metal part 231 to the second outer arc splitter plate 31 of the arc splitter stack 24 which flanks it, and there forms the first sub-arc of the switching arc, which divides into a series of sub-arcs in the arc splitter stack 24.

FIG. 3 shows an exemplary fixed contact guide rail 28. This comprises a first, U-shaped sheet metal strip 328, which is connected at its first end to the fixed contact piece 19 and at its second end to a rectangular rail section 329. The rail section 329 is a roughly rectangular sheet metal part, which with its first broad side 330 flanks the first outer arc splitter plate 29 of the arc splitter stack 24. When entering the arc-quenching chamber 23, the arc, which has its first foot on the U-shaped sheet metal strip 328, transfers from the rail section 329 to the first outer arc splitter plate 29 of the arc splitter stack 24 which flanks it, and there forms a further sub-arc of the switching arc, which divides into a series of sub-arcs in the arc splitter stack 24.

Both the fixed contact guide rail 28 and the arc guide rail 30 can be made, for example, of a ferromagnetic base material.

The magnetic field of the blowing magnets 27 is aligned so that, in accordance with Lenz's law, it drives the switching arc along the fixed contact guide rail 28 and the arc guide rail 30 through the antechamber space 26 to the inlet 25 of the arc splitter stack 24. Furthermore, the current-carrying conductor of the current path in the area of the antechamber 26 can run so that the magnetic field, which surrounds it when current flows, is aligned so that, in accordance with Lenz's rule, it drives the switching arc along the fixed contact guide rail 28 and the arc guide rail 30 through the antechamber 26 to the inlet 25 of the arc splitter stack 24. All in all, the switching arc is therefore guided by magnetic forces away from the contact point 18 into the arc-quenching chamber 23.

At the same time, the two feet of the switching arc travel on the surface of the fixed contact guide rail 28 and the arc guide rail 30. In the event of high short circuit currents, the fixed contact guide rail 28 and arc guide rail 30 can exhibit a high degree of material fusing after the arc has been quenched. This can limit the life in the event of a short circuit and the magnitude of the maximum switching capability of the device. This is because, when the material fuses, it can partially vaporize or spatter, and, as a result of the metal mist produced, short circuits can occur in the arc splitter stack 24 or even between the fixed contact guide rail 28 or the arc guide rail 30 and the outer arc splitter plates 29, 31 flanking them.

To address this, the fixed contact guide rail 28 can be coated with a material which increases the thermal stability on the first broad side 330 of its rail section 329, and the arc guide rail 30 similarly coated on the first broad side 232 of its rectangular sheet metal part 231. The coated points are focused upon with regard to fusing. It can be desirable not to coat the entire surface of the fixed contact guide rail 28 and of the arc guide rail 30 with this material.

The reason for this is that materials which increase the thermal stability of the ferromagnetic base material can also reduce the arc mobility. As a result of this, the arc would travel more slowly, which would be counter to the desired fast quenching of the arc. Because only the above-mentioned parts of the fixed contact guide rail 28 and the arc guide rail 30 are coated with this material in an exemplary embodiment, high arc mobility can be retained on those parts which guide the arc from the contact point to the arc-quenching chamber 23, but fusing of the material can be prevented at desired critical points.

An exemplar embodiment according to the disclosure enables two intrinsically contradictory requirements to be fulfilled, namely to guarantee high arc mobility and also to prevent fusing of the material at desired points.

A composite material is disclosed, which apart from a first constituent, the melting point of which does not exceed that of the ferromagnetic base material and has a better conductivity than the ferromagnetic base material, also has at least one second constituent, which melts at a higher temperature than the first constituent and also has a higher vaporization point than the first constituent. Such a material can be used as material which increases the thermal stability. The second constituent with the higher melting point, which initially does not also fuse under the effect of the arc, can be used to prevent the first constituent, which is fused under the effect of the arc and has good conductivity, from spattering. The quantity and the melting point of the second constituent can be chosen so that this effect is achieved.

An exemplary coating used according to the disclosure includes (e.g. consists of), for example, 70% copper and 30% tungsten, and can be applied by thermal spraying in a 0.25 mm thick coating and is subsequently compressed by cold rolling or by other suitable application.

A second example of a coating which can be used according to the disclosure includes (e.g., consists of) 55% silver and 45% molybdenum, and can be applied by cold roll plating in a 0.1 mm thick coating or by other suitable application.

A third example of a coating which can be used according to the disclosure includes (e.g., consists of) 50% silver and 50% tantalum, and can be processed by hot roll plating after a coating which is about 0.15 mm thick or by other suitable application.

In a fourth example of a coating which can be used according to the disclosure, tungsten carbide powder is applied to the base material and pressed into the surface of the base material by cold rolling. This can result in a functional coating of base material and tungsten carbide on the surface of the base material.

Known ferromagnetic strips made from soft iron, iron-cobalt or nickel-cobalt, which after coating can be shaped as desired and further processed by stamping and bending, can be used as the base material.

In order to prevent diffusion of the coating into the base material, an optional intermediate coating can be provided between the composite coating and the base material. In a fifth example of a coating which can be used according to the disclosure, for this purpose a roughly 10 μm thick nickel coating can be initially applied galvanically to the base material, and a roughly 0.2 mm thick composite coating, which includes (e.g., consists of) 40% copper and 60% tungsten carbide, is subsequently fused on.

Naturally, the disclosure is not restricted to the coatings cited in the examples. For example, any coating which increases the thermal stability of the ferromagnetic base material is encompassed by the disclosure when it is used as a functional layer only in the areas of the fixed contact guide rail and arc guide rail flanking the arc splitter stack.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

| | |
|---|---|
| 10 | Circuit breaker |
| 11 | Housing half-shell |
| 12, 13 | Terminal mounting space |
| 14, 15 | Narrow side |
| 16, 17 | Connecting terminal |
| 18 | Contact point |
| 19 | Fixed contact piece |
| 20 | Swiveling contact carrier |
| 21 | Movable contact piece |
| 22 | Striker armature system |
| 23 | Arc-quenching chamber |
| 24 | Arc splitter stack |
| 25 | Inlet |
| 26 | Antechamber |
| 27 | Blowing magnet |
| 28 | Fixed contact guide rail |
| 29 | First outer arc splitter plate |
| 30 | Arc guide rail |
| 31 | Second outer arc splitter plate |
| 230 | Sheet metal strip |
| 231 | Sheet metal part |
| 232 | First broad side of sheet metal part 231 |
| 328 | U-shaped part |
| 329 | Rail section |
| 330 | First broad side of rail section 329 |

What is claimed is:

1. A current-limiting arc-quenching device for an electric switching device, comprising:
at least one contact point that has a fixed and a movable contact piece; and
an arc splitter stack for quenching a switching arc when generated, the arc splitter stack being located between a fixed contact guide rail and an arc guide rail that is associated with the movable contact piece, such that feet of the switching arc, which is generated when the contact point is opened, run along the fixed contact guide rail and the arc guide rail, the switching arc traveling into the arc splitter stack, wherein the fixed contact guide rail and the arc guide rail are coated with a coating material in areas which flank the arc splitter stack.

2. The current-limiting arc-quenching device as claimed in claim 1, wherein the fixed contact guide rail and the arc guide rail are made of a ferromagnetic material.

3. The current-limiting arc-quenching device as claimed in claim 1, wherein the fixed contact guide rail and the arc guide rail are each coated with the coating material which increases thermal stability in the areas which flank the arc splitter stack.

4. The current-limiting arc-quenching device as claimed in claim 3, wherein the coating material is a metal with electrical conductivity.

5. The current-limiting arc-quenching device as claimed in claim 3, wherein the coating material is a composite material comprising:
a first constituent which is electrically conductive and has melting and vaporization points which do not exceed melting and vaporization points of the base material of the fixed contact guide rail and arc guide rail; and
a second constituent which has melting and vaporization points which are higher than the melting and vaporization points of the base material of the fixed contact guide rail and arc guide rail.

6. The current-limiting arc-quenching device as claimed in claim 1, comprising:
at least one diffusion-inhibiting intermediate coating between the coating material and a base material beneath the coating material.

7. The current-limiting arc-quenching device as claimed in claim 6, wherein the intermediate coating is made of a ferromagnetic material.

8. The current-limiting arc-quenching device as claimed in claim 2, wherein the fixed contact guide rail and the arc guide rail are each coated with the coating material which increases thermal stability in the areas which flank the arc splitter stack.

9. The current-limiting arc-quenching device as claimed in claim 8, comprising:
at least one diffusion-inhibiting intermediate coating between the coating material and a base material beneath the coating material.

10. The current-limiting arc-quenching device as claimed in claim 9, comprising:
at least one diffusion-inhibiting intermediate coating between the coating material and a base material beneath the coating material.

11. An electric switching device, comprising:
at least one contact point that has a fixed and a movable contact piece; and
a current-limiting arc-quenching device having an arc splitter stack for quenching a switching arc when generated, the arc splitter stack being located between a fixed contact guide rail and an arc guide rail that is associated with the movable contact piece, such that feet of a switching arc, which is generated when the contact point is opened, run along the fixed contact guide rail and the arc guide rail, the switching arc traveling into the arc splitter stack, wherein the fixed contact guide rail and the arc guide rail are coated with a coating material in areas which flank the arc splitter stack.

12. The electric switching device of claim 11, wherein the device is one of a circuit breaker and a motor protection circuit breaker.

13. An electric switching device according to claim 12, wherein the fixed contact guide rail and the arc guide rail are made of a ferromagnetic material.

14. An electric switching device according to claim 12, wherein the fixed contact guide rail and the arc guide rail are each coated with the coating material which increases thermal stability in the areas which flank the arc splitter stack.

15. A composite material for coating a fixed contact guide rail and an arc guide rail in areas thereof flanking an arc splitter stack in a service switching device, the composite material comprising:
a first constituent which is electrically conductive and has melting and vaporization points which do not exceed melting and vaporization points of a base material of the fixed contact guide rail and arc guide rail; and
a second constituent which has melting and vaporization points which are higher than the melting and vaporization points of the base material of the fixed contact guide rail and arc guide rail.
